(19) United States
(12) Patent Application Publication
(10) Pub. No.: US 2012/0049511 A1
(43) Pub. Date: Mar. 1, 2012

(54) Flexible Downspout Extension

(75) Inventors: Robert B. Bell, Douglasville, GA (US); John J. McNichol, Holland, PA (US); Joseph K. Wolf, Lancaster, PA (US); J. Michael Connelly, Manheim, PA (US); Vincent Kehs, Barto, PA (US)

(73) Assignee: Amerimax Home Products, Inc.

(21) Appl. No.: 12/873,632

(22) Filed: Sep. 1, 2010

(51) Int. Cl. F16L 51/02

(52) U.S. Cl. 285/226

(57) ABSTRACT

A downspout extension has multiple connector segments at each opposing end of a flexible central portion to allow the connection of the downspout extension to substantially any conventional downspout configuration. The multiple connector segments at each respective end of the downspout extension are arranged in order of increasing size in terms of cross-sectional area from the outermost segment to the connector segment adjacent the central portion. Rectangular segment configurations are located at one end of the downspout extension to correspond to the majority of conventional downspout configurations, while the opposing end of the downspout extension is formed with circular connector segments which for connection to drainage pipes so that the downspout extension will direct rainwater from the downspout into the drainage pipe. Cut lines are formed adjacent to each of the connector segments to facilitate the removal of the outermost connector segments when the smaller connector segments are not needed.

### FIELD OF THE INVENTION

This invention relates generally to an apparatus for conveying rainwater away from a downspout and, more particularly, to a downspout extension that provides a connector adapted to engage substantially any known conventional downspout configuration without restricting the flow from one end of the downspout extension to the other.

### BACKGROUND OF THE INVENTION

Gutters and downspouts are mounted on most residential and commercial structures along the lower edge of the roof of the structure to receive water draining off of the roof, such as during a rainstorm. Gutters come in many different styles, including K gutter, half round gutter, or commercial box gutter, but all are generally formed with an open top through which water is received into a trough or channel that delivers the water by gravity to a downspout for discharge away from the building structure. Gutters are often mounted on a plurality of hangers that are spaced along the length of the gutter and fastened to fascia boards by nails or screws such that the gutter is suspended from the hangers. The downspout is connected to an outlet of the gutter to provide a conduit to drain the collected rainwater from the gutter for discharge along the surface of the ground and direct the rainwater away from the building structure.

Typically, the downspout is provided with an elbow at the discharge end thereof to direct the discharged rainwater into a generally horizontal direction away from the building on which the downspout is mounted. These elbows at the discharge end of the downspout have a short length and are only effective to provide a direction for the discharge of the rainwater away from the building; therefore, the rainwater is often discharged too close to the building and the discharged rainwater can find a way into the basement of the building to cause cracks or leaks. Splashblocks can be provided to receive the discharged rainwater from the downspout elbow and help direct the rainwater away from the building. Other attempts to divert the rainwater from downspouts include a non-flexible extension, which is typically a generally horizontally disposed piece of downspout affixed to the discharge end of the elbow, and a flexible downspout extension that can be bent in a desired direction to redirect the discharged rainwater.

Occasionally, a landowner will bury into the ground a drainage pipe or conduit for conveying rainwater to a remote location, such as a groundwater restoration cistern, or at least some point remotely distant from the building. The downspout is then connected to the drainage pipe by the downspout extension so that the rainwater is discharged at a location that will not infiltrate into the basement of the building. Once such downspout extension can be found in U.S. Pat. No. 5,813,701, granted to Christopher Noble on Sep. 29, 1998. The Noble downspout extension is formed with multiple adaptor portions at each end of a flexible central portion. The adaptor segments at the respective ends of the downspout extension are separated by a cut line to allow the installer of the downspout extension to separate the outwardmost adaptor segment from the downspout extension so that the inner adaptor segment could be utilized to connect to the downspout. The Noble downspout extension is formed so that the adaptor segments at one end of the downspout extension will be capable of fitting into the corresponding adaptor segment at the opposing end of the downspout extension so that multiple downspout extensions can be hooked together in a serial manner.

In U.S. Pat. No. 6,041,825, granted to Jeffrey Smith and Christopher Noble on Mar. 28, 2000, the downspout extension was formed with multiple adaptor segments at each end of the flexible central portion of the downspout extension. More particularly, the adaptor segments begin with a large rectangular configuration on the outwardmost ends of the downspout extension followed inwardly by a smaller rectangular adaptor segment and then inwardly a smaller circular adaptor segment. Each adaptor segment is separable from the inwardly disposed adaptor segment by a cut line so that the outward adaptor segments can be removed. Accordingly, when the outwardmost adaptor segment was utilized to connect to the discharge end of the downspout, the rainwater, and any debris entrained within the flow of the rainwater had to pass from a larger adaptor configuration into a smaller adaptor configuration, thus forming a restriction on the flow through the downspout extension.

A differently configured flexible downspout extension is disclosed in U.S. Pat. No. 7,017,614 granted on Mar. 28, 2006, to Stephen Handley. In the Handley downspout extension, one end of the downspout extension was formed with multiple rectangular adaptor segments arranged in decreasing sizes from the outwardmost adaptor segment to the innermost adaptor segment, while the opposing end of the downspout extension was provided with circular connector sized for attachment to a circular drainage pipe or conduit. Thus, one end of the flexible downspout extension is formed for connection to a downspout, while the opposing end is formed for connection to a drainage pipe. As with the Noble downspout extensions, the connection of the downspout to the outwardmost adaptor segment causes the flow to be constricted through decreasingly smaller adaptor segments before reaching the central flexible portion.

None of the known downspout extensions are configured to be connected to all of the known conventional sizes of downspouts. Conventional gutters and corresponding downspouts are formed in a number of different sizes and configurations resulting in the downspout being formed in a 2 inch by 3 inch or a 3 inch by 4 inch rectangular shape, a 3 inch by 3 inch square shape, or a 3 inch round or a 4 inch round shape. These five downspout configurations cover a large majority of downspouts. The most common configurations of downspouts are the 2 inch by 3 inch and the 3 inch by 4 inch rectangular shapes. Drainage conduits are typically circular and are mostly 4 inches in diameter, although a 3 inch circular conduit can also be utilized.

It would be desirable to provide a downspout extension that is configured to provide a connector segment for each common conventional size and shape of downspout, arranged in a manner that flow through the downspout extension is not constricted as it passes into the central flexible portion that can be bent to direct the flow of rainwater into a desired direction in into a desired receiver.

### SUMMARY OF THE INVENTION

It is an object of this invention to overcome the disadvantages of the prior art by providing a downspout extension formed with a multiple connector segments that will connect to a majority of downspout configurations.

It is another object of this invention to provide a downspout extension that is arranged so that rainwater and debris entrained within the rainwater will not be constricted in flowing into the central flexible portion of the downspout extension.

It is a feature of this invention that the connector segments corresponding to the most utilized downspout configurations are formed at one end of the downspout extension.

It is another feature of this invention that the connector segments corresponding to the most utilized drainage conduit configurations are formed at the end of the downspout extension opposite the end on which the downspout connectors are formed.

It is still another feature of this invention that the connector segments are arranged at each respective end of the downspout extension in an increasing size from the outwardmost connector segment to the innermost connector segment and to the central flexible portion.

It is an advantage of this invention that rainwater and debris entrained within the flow of rainwater passing through the discharge end of the downspout is not constricted by the structure of the downspout extension into the flexible central portion.

It is yet another feature of this invention that each of the multiple connector segments at each respective end of the downspout extension incorporate a cut line to allow the separation of the outward connector segments from the downspout extension.

It is another advantage of this invention that most uses of the downspout extension will result in one of the rectangular connector segments being affixed to the discharge end of the downspout, while the opposing end of the downspout is connected to a discharge conduit.

It is still another advantage of this invention that the rainwater discharged from a downspout into the downspout extension will not be passed through an opening having a smaller cross-sectional area than the downspout to pass into the flexible central portion of the downspout extension.

It is another feature of this invention that the flexible central portion of the downspout extension has a larger cross-sectional area than any of the connector segments at either end of the downspout extension.

It is still another feature of this invention that the connector segments located next to the flexible central portion to either end thereof have approximately the same cross-sectional area.

It is yet another advantage of this invention that the passage of rainwater into the flexible central portion from the connector segment at either end of the central portion will not be restricted exiting the opposing end of the flexible central portion into the opposing connector segment.

It is still another object of this invention to provide a downspout extension that has a substantially unrestricted flow through capability into and out of the flexible central portion thereof.

It is still a further object of this invention to provide a downspout extension that is connectable to the discharge end of a downspout to direct rainwater away from the building on which the downspout is mounted, which is durable in construction, inexpensive of manufacture, carefree of maintenance, facile in assemblage, and simple and effective in use.

These and other objects, features and advantages are accomplished according to the instant invention by providing a downspout extension has multiple connector segments at each opposing end of a flexible central portion to allow the connection of the downspout extension to substantially any conventional downspout configuration. The multiple connector segments at each respective end of the downspout extension are arranged in order of increasing size in terms of cross-sectional area from the outermost segment to the connector segment adjacent the central portion. Rectangular segment configurations are located at one end of the downspout extension to correspond to the majority of conventional downspout configurations, while the opposing end of the downspout extension is formed with circular connector segments which for connection to drainage pipes so that the downspout extension will direct rainwater from the downspout into the drainage pipe. Cut lines are formed adjacent to each of the connector segments to facilitate the removal of the outermost connector segments when the smaller connector segments are not needed.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1A is a front elevational view of the rectangular connector end of a downspout extension incorporating the principles of the instant invention, the flexible central portion of the downspout extension being broken away along with the opposing connector end;

FIG. 1B is a front elevational view of the circular connector end of the downspout extension opposite of the rectangular connector end shown in FIG. 1A, the flexible portion of the downspout extension being broken away;

FIG. 2A is a side elevational view of the portion of the downspout extension showing the rectangular connector end depicted in FIG. 1A;

FIG. 2B is a side elevational view of the portion of the downspout extension showing the circular connector end depicted in FIG. 1B;

FIG. 3 is a perspective view of the downspout extension shown in FIGS. 1A through 2B, the middle of the flexible central portion being broken away for purposes of clarity;

FIG. 4 is an enlarged top plan view of the downspout extension looking into the rectangular end; and

FIG. 5 is an enlarged top plan view of the downspout extension similar to that of FIG. 4, but depicting as dashed lines the hidden portions of the connector segments at the circular connector end.

### DETAILED DESCRIPTION OF THE PREFERRED EMBODIMENT

Referring now to the drawings, a downspout extension incorporating the principles of the instant invention can best be seen. The downspout extension 10 is formed from plastic and has a central flexible portion 15 formed in a conventional manner with corrugated pleats 17 that permit the central portion 15 to bend in substantially any direction. A rectangular connector end 12 is integrally formed on one end of the flexible central portion 15, while a circular connector end 14 is integrally formed on the opposing end of the flexible central portion 15. The connector ends 12, 14 are formed with multiple connector segments, as will be described in greater detail below, for connection of the downspout extension 10 to either a downspout (not shown) mounted in a conventional manner on a building, and/or to a drainage pipe (not shown) that is typically buried to provide a conduit for rainwater to be conveyed away from the building on which the downspout is mounted.

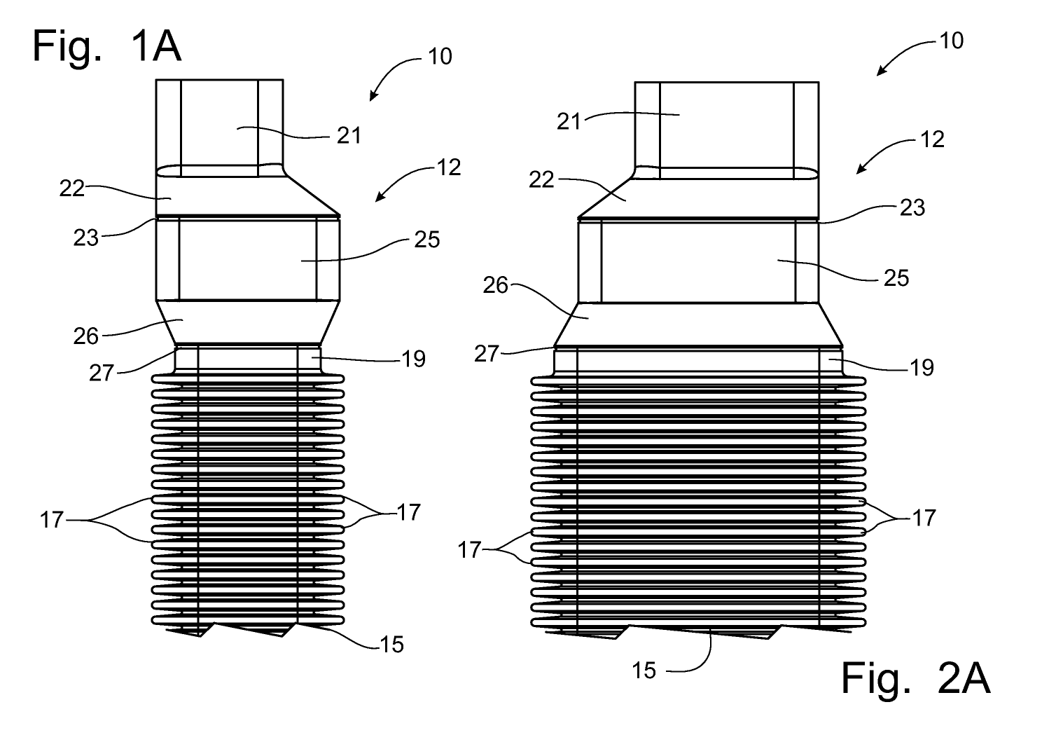

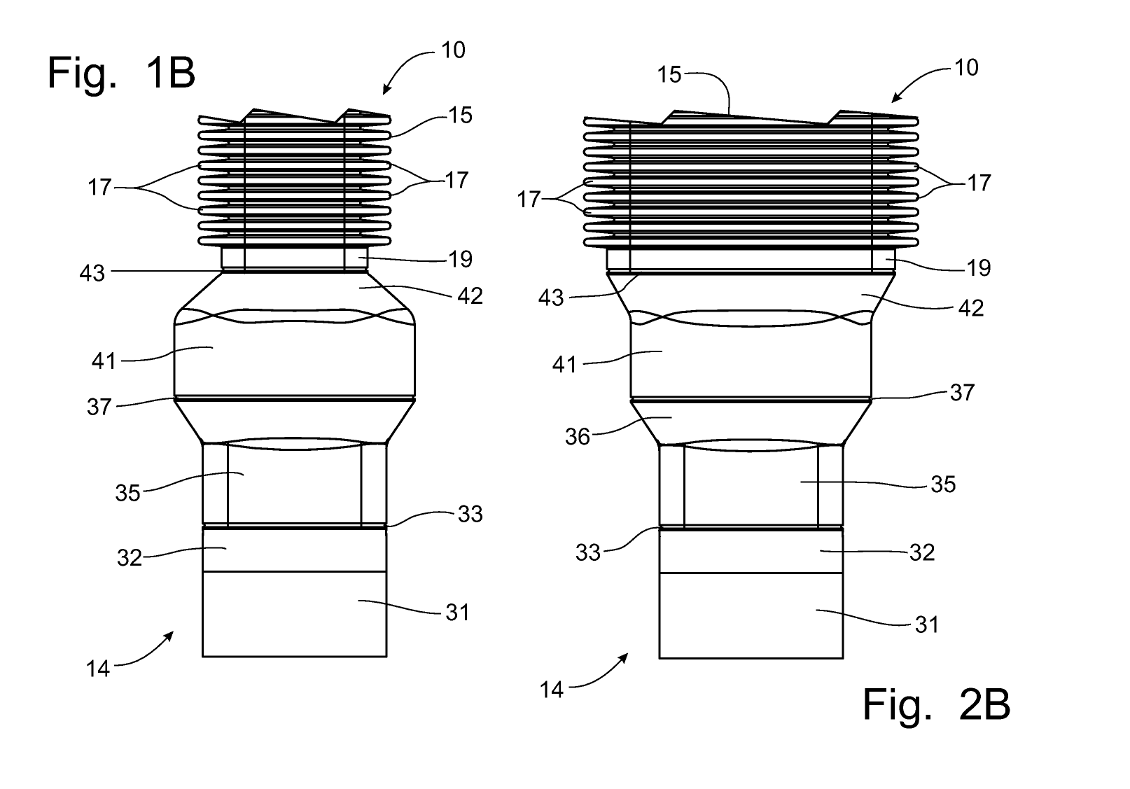

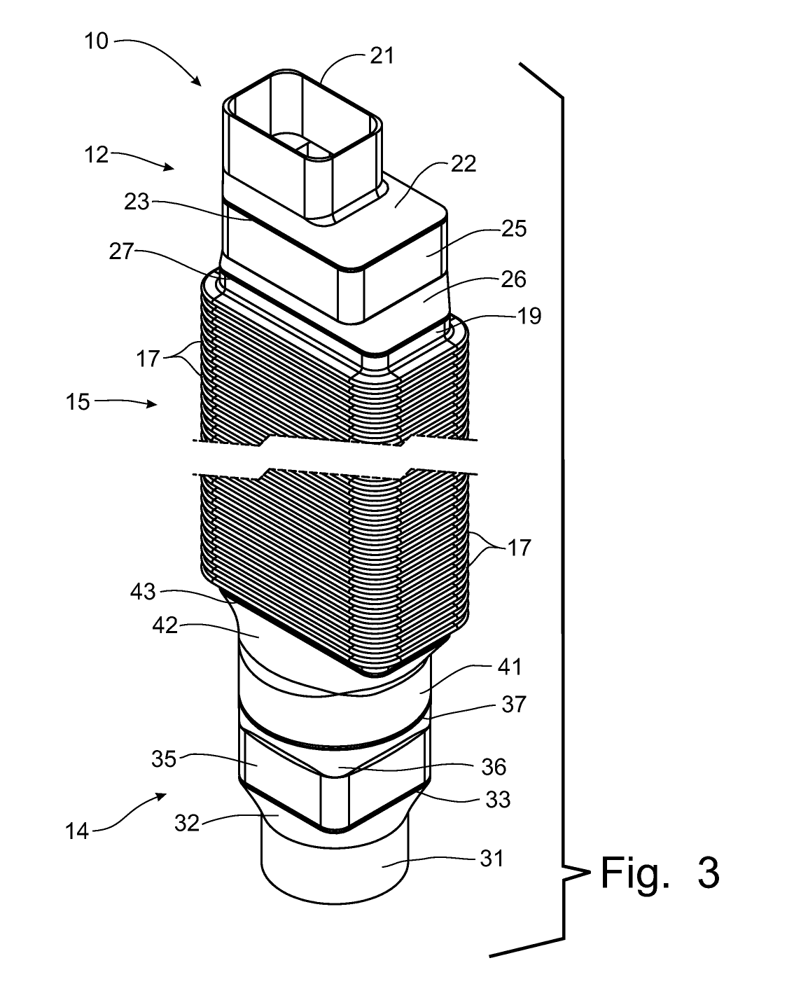

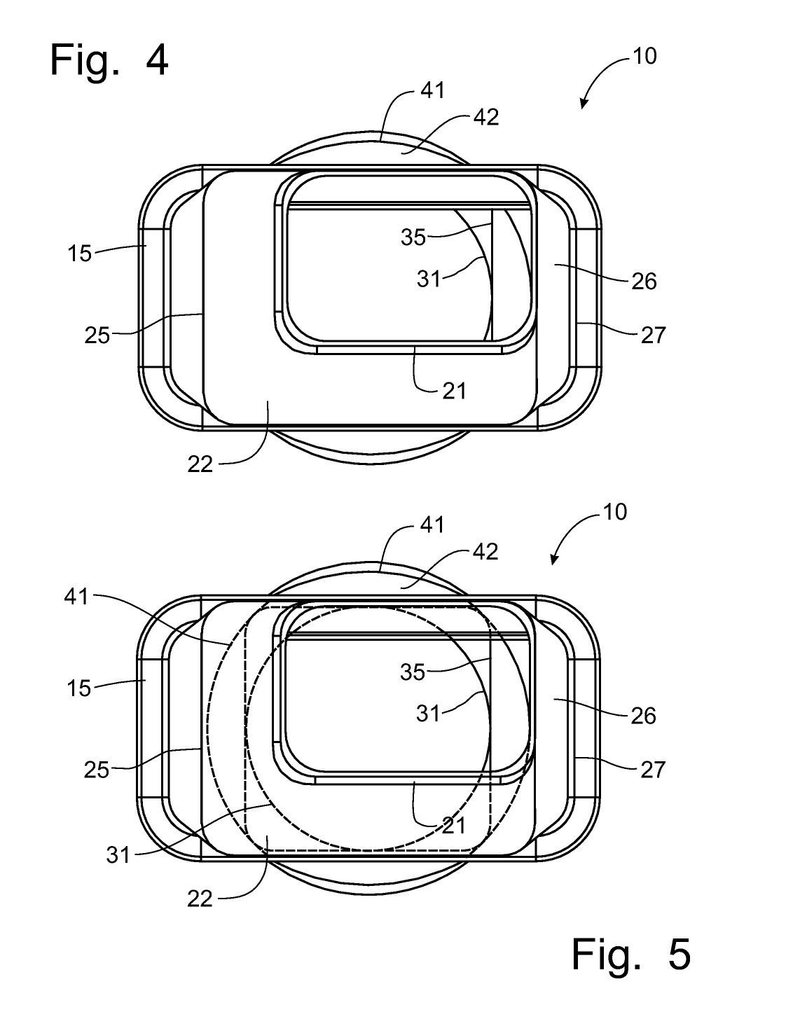

The rectangular connector end 12 is best seen in FIGS. 1A, 2A and 3. The rectangular connector end 12 has a first rectangular connector segment 21 at the distal end of the downspout extension 10. This first connector segment 21 is preferably sized to mount onto a two inch by three inch rectangular downspout (not shown), which is one of the conventional downspout sizes. A second rectangular connector segment 25 is formed inwardly of the first rectangular connector segment 21 so as to be located between the flexible central portion 15 and the first connector segment 21. The second connector segment 25 is sized to fit over and mount to a three inch by four inch rectangular downspout (not shown), which is also a conventional downspout size.

A first transition area 22 is integrally formed between the first connector segment 21 and the second connector segment 25 to provide a smooth transition from the first rectangular connector segment 21 and the second rectangular connector segment 25 for the flow of rainwater from the first connector segment 21 to the central portion 15. At the inward edge of the first transition area 22 lies a first cut groove 23 that is positioned at the outermost edge of the second connector segment 25. The cut groove 23 defines a thinned area of the plastic material at which a knife or other sharp instrument can be inserted to separate the first connector segment 21 and the first transition area 22 from the second rectangular connector segment 25. In this manner, the second connector segment 25 can be secured to a suitably sized downspout and the first connector segment 21 and associated transition area 22 thrown away.

A second transition area 26 is also provided between the second rectangular connector segment 25 and the inside flange 19 of the corrugated central portion 15. A second cut groove 27 is also provided at the junction of the second transition area 26 and the inside flange 19 adjacent the rectangular connector end 12 to allow the entire rectangular connector end 12 to be separated from the flexible central portion 15. The two rectangular connector segments 21, represent the two most common downspout sizes utilized on residential building construction. Thus, the downspout extension 10 is configured with the two connector segments representing the most frequently found rectangular downspouts so that in most cases one of the rectangular connector segments 21, 25 will be utilized to connect to the discharge end of a downspout.

The circular connector end 14 is formed in a similar manner to the rectangular connector end 12, but with differently configured connector segments, as will be described in greater detail below. Where the rectangular connector end 12 is configured to be utilized most frequently for connection to a downspout, the circular connector end 14 is configured to be connected most frequently to a drainage pipe that conveys rainwater away from the building on which the downspout is mounted.

Accordingly, the outermost circular connector segment 31 is sized to be connected to a three inch diameter drainage conduit (not shown). One skilled in the art will recognize that downspouts are also formed in a circular configuration having a three inch diameter. Therefore, the outermost circular connector segment 31 can be utilized to connect as needed to either a downspout or a drainage pipe. Inwardly from the outermost circular connector segment 31 is formed a square three inch by three inch connector segment 35 that is sized to connect to a corresponding three inch square downspout. A third transition area 32 lies between the outermost circular connector segment 31 and the square connector segment 35 to provide a smooth flow of rainwater from the smaller three inch diameter circular connector segment 31 to the slightly larger three inch square connector segment 35. A cut groove 33 is formed at the inner end of the third transition area 32 at the edge of the square connector segment 35 to allow the outermost circular connector segment 31 to be removed from the downspout extension 10 and allow the utilization of the square connector segment 35.

Further inwardly from the square connector segment 35 lies a second circular connector segment 41 sized to mount to a four inch drainage pipe, or to a four inch diameter, circular downspout. The most commonly used drainage pipes are four inch diameter plastic corrugated conduits that are belled at one end for connection to another section of drainage pipe (not shown), on in this situation to the four inch diameter connector segment 41. A fourth transition area 36 extends from the inner end of the square connector segment 35 to the outer edge of the four inch diameter circular connector segment 41, terminating in a fourth cut groove 37 that allows both the three inch diameter connector segment 31 and the three inch square connector segment 35, along with the third and fourth transition areas 32, 36, to be removed from the four inch circular connector segment 41 so that this connector segment 41 can be utilized.

A fifth transition area 42 extends from the inner edge of the four inch circular connector segment 41 to the adjacent inside flange 19 of the corrugated central portion 15 with a fifth cut groove 43 being formed at the joint between the inside flange 19 and the fifth transition area 42 to permit the removal of the entire circular connector end 14 from the central portion 15. The three and four inch diameter connector segments 31, 41 represent the most commonly utilized drainage pipe sizes, with the four inch drainage conduit being more popular than the three inch diameter version. Thus, the rectangular connector end 12 is most frequently used to connect to the discharge end of a downspout while the circular connector end 14 is most frequently utilized to connect to common drainage pipes to permit rainwater to be transported from the downspout through the downspout extension and outwardly through the drainage pipe.

For those instances where the circular connector end 14 is utilized to connect to a circular or to a square downspout, the opposing rectangular connector end 12 would require an appropriate rectangular-to-circular adaptor to permit connection thereof to a typical drainage pipe. Such connectors can be found in configurations that will connect to either the first or the second rectangular connector segment 21, 25; however, the second rectangular connector segment 25 would be the segment preferably used so that the first rectangular connector segment 21 does not present a restriction in size for the movement of rainwater through the downspout extension 10.

One skilled in the art will recognize that the connector segments on each of the connector ends 12, 14 are arranged in an increasing size, as defined by the cross-sectional area of the respective connector segment, from the distal end of the downspout extension 10 to the central corrugated portion 15. At the rectangular connector end 12, the smaller 2×3 connector segment 21 is outside of the larger 3×4 rectangular connector segment 25. At the circular connector end 14, the outermost three inch diameter circular connector segment 31 is smaller than the inwardly positioned 3×3 square connector segment 35, which in turn is smaller than the innermost four inch circular connector segment 41. The central corrugated portion preferably has a rectangular central opening through the portion of two and a half inches by five inches to provide a cross-sectional area that is substantially the same as the cross-sectional area of the adjacent connector segments 25, 41 at opposing ends thereof. Thus, the downspout extension 10 expands in cross-sectional area from one connector segment to another through to the flexible central portion 15 and also to the next adjacent connector segment. In situations where the downstream end of the downspout extension 10 is connected to a four inch drainage pipe, the downspout extension 10 provides a non-constrictive flow path from the downspout to the drainage pipe.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A downspout extension for connection to a discharge end of a downspout mounted on a building structure, comprising:
a flexible central portion having first and second ends, said flexible central portion being formed with corrugations that allow said first end to be moved relative to said second end; and
first and second connector ends integrally formed with said first and second ends, respectively, of said flexible central portion, said respective said connector end including at least two connector segments arranged in progressively decreasing cross-sectional areas from the corresponding said end of said corrugated central portion.

2. The downspout extension of claim 1 wherein said first and second connector ends comprise:
a rectangular connector end integrally formed with said first end of said flexible central portion, said rectangular connector end having at least two rectangular connector segments, each rectangular connector segment having a cross-sectional area, said rectangular connector segments being arranged in a progressively smaller sequence from said first end of said flexible central portion; and
a circular connector end integrally formed with said second end of said flexible central portion, said circular connector end having at least two circular connector segments, each circular connector segment having a cross-sectional area, said circular connector segments being arranged in a progressively smaller sequence from said second end of said flexible central portion.

3. The downspout extension of claim 2 wherein each said connector segment incorporates a transition area separating each connector segment from the adjacent structure inwardly thereof toward said central flexible portion, each said transition area extending from the corresponding connector segment to the inwardly adjacent structure to provide an integral structural configuration from said flexible central portion to the distal connector segment from each respective end of said flexible central portion.

4. The downspout extension of claim 3 wherein each said connector segment further includes a cut groove allows the corresponding connector segment to be separated from the downspout extension by cutting through the cut groove.

5. The downspout extension of claim 4 wherein each said cut groove is located between the corresponding said transition area and the structure inwardly of said corresponding transition area and consists of a thinned material thickness extending circumferentially around the structure inwardly of said corresponding transition area.

6. The downspout extension of claim 2 wherein said rectangular connector segments includes an inwardmost rectangular connector segment having dimensions permitting connection thereof to a three inch by four inch downspout, and an outwardmost rectangular connector segment having dimensions permitting connection thereof to a two inch by three inch downspout.

7. The downspout extension of claim 6 wherein said outwardmost rectangular connector segment is positioned at a corner of said inwardmost connector segment.

8. The downspout extension of claim 2 wherein said circular connector segments include an inwardmost circular connector segment having dimensions permitting connection thereof to a four inch diameter downspout, and an outwardmost circular connector segment having dimensions permitting connection thereof to a three inch diameter downspout.

9. The downspout extension of claim 8 wherein a square connector segment is positioned between said inwardmost circular connector segment and said outwardmost circular connector segment, said square connector segment being configured for connection to a three inch square downspout.

10. The downspout extension of claim 9 wherein said central flexible portion has an interior passageway having dimensions of approximately five inches by two and one-half inches.

11. In a downspout extension for connection to a discharge end of a downspout mounted on a building structure, said downspout extension having a corrugated central portion having first and second ends, the improvement comprising:
first and second connector ends integrally formed with said first and second ends, respectively, of said corrugated central portion, said respective said connector end including at least two connector segments arranged in progressively decreasing cross-sectional areas from the corresponding said end of said corrugated central portion.

12. The downspout extension of claim 11 wherein said first connector end includes an innermost rectangular connector segment and an outermost rectangular connector segment having a smaller cross-sectional area than said innermost rectangular connector segment, said second connector end including an innermost circular connector segment and an outermost circular connector segment having a smaller cross-sectional area than said innermost circular connector segment

13. The downspout extension of claim 12 wherein said second connector end further includes a square connector segment positioned between said innermost circular connector segment and said outermost circular connector segment, said square connector segment having a cross-sectional area smaller than said innermost circular connector segment and larger than said outermost circular connector segment.

14. The downspout extension of claim 12 wherein each said connector segment includes a transition area located inwardly of said connector segment to provide a continuous internal flow path through said downspout extension from said outermost rectangular connector segment to said outermost circular connector segment.

15. The downspout extension of claim 14 wherein each said connector segment further includes a cut groove between the corresponding said transition area and the inwardly adjacent structure, each said cut groove including a thinned material thickness to facilitate a cutting through said cut groove to affect a separation of said connector segment from the inwardly adjacent structure.

16. A downspout extension interconnecting a discharge end of a downspout mounted on a building structure and a drainage conduit to convey rainwater from said downspout away from said building structure, comprising:
a flexible central portion having first and second ends, said flexible central portion being formed with corrugations that allow said first end to be moved relative to said second end;
a rectangular connector end integrally formed with said first end of said flexible central portion, said rectangular connector end having at least two rectangular connector segments including an innermost rectangular connector segment with a first cross-sectional area and an outermost rectangular connector segment with a second cross-sectional area, said first cross-sectional area being larger than said second cross-sectional area; and
a circular connector end integrally formed with said second end of said flexible central portion, said circular connector end having at least two circular connector segments including an innermost circular connector segment with a third cross-sectional area and an outermost circular connector segment with a fourth cross-sectional area, said third cross-sectional area being larger than said fourth cross-sectional area.

17. The downspout extension of claim 16 wherein said circular connector end further includes a square connector segment positioned between said innermost circular connector segment and said outermost circular connector segment, said square connector segment having a fifth cross-sectional area smaller than said third cross-sectional area and larger than said fourth cross-sectional area.

18. The downspout extension of claim 17 wherein each said connector segment includes a transition area located inwardly of said connector segment to provide a continuous internal flow path through said downspout extension from said outermost rectangular connector segment to said outermost circular connector segment, each said connector segment further includes a cut groove between the corresponding said transition area and the inwardly adjacent structure to facilitate a separation of said connector segment from the inwardly adjacent structure.

19. The downspout extension of claim 16 wherein said innermost rectangular connector segment is sized to permit connection thereof to a three inch by four inch downspout, said outermost rectangular connector segment being sized for connection thereof to a two inch by three inch downspout, said innermost circular connector segment being sized to permit connection thereof to a four inch diameter drainage conduit, said outermost circular connector being sized for connection to a three inch diameter downspout, said central flexible portion having an interior passageway having dimensions of approximately five inches by two and one-half inches.

20. The downspout extension of claim 19 wherein said outermost rectangular connector segment is positioned at a corner of said innermost connector segment.
